(19) United States
(12) Patent Application Publication
(10) Pub. No.: US 2024/0037595 A1
(43) Pub. Date: Feb. 1, 2024

(54) INFORMATION CONTROLLING APPARATUS, INFORMATION CONTROLLING METHOD, AND COMPUTER-READABLE MEDIUM

(71) Applicant: NEC Corporation, Minato-ku, Tokyo (JP)

(72) Inventors: Taichi OKUMURA, Tokyo (JP); Noriyuki HIRAMOTO, Tokyo (JP)

(73) Assignee: NEC Corporation, Minato-ku, Tokyo (JP)

(21) Appl. No.: 18/282,028

(22) PCT Filed: Mar. 19, 2021
(86) PCT No.: PCT/JP2021/011506

§ 371 Date: Sep. 14, 2023

(51) Int. Cl. G06Q 30/0226; G06Q 30/0207; G06Q 20/40

(52) U.S. Cl. CPC G06Q 30/0233; G06Q 30/0236; G06Q 20/40145

(57) ABSTRACT

An information controlling apparatus includes: a first registering unit configured to register registration information linking a predetermined user's biometric information and personal information; an acquiring unit configured to acquire the biometric information of the user; a biometric authentication controlling unit configured to control biometric authentication of the user; a second registering unit configured to register action information pertaining to the entry into or exit from a first facility or purchase information pertaining to the purchased product or service at the first facility linked to the registration information of the user whose biometric authentication has succeeded; a determining unit configured to determine, based on the registration information, a service suitable for the user and available at a second facility; and a processing unit configured to perform a process pertaining to providing of the service.

### TECHNICAL FIELD

The present disclosure relates to information controlling apparatuses, information controlling methods, and computer-readable media.

### BACKGROUND ART

In recent years, with the advancement of biometric authentication technology, including facial authentication, various services utilizing biometric authentication technology are being introduced. For example, Patent Literature 1 discloses an authentication system that associates a user's biometric data and preference data with the user and provides product information based on the biometric authentication and the preference data. Meanwhile, Patent Literature 2, for example, discloses a technique pertaining to a service providing apparatus that acquires a customer's action information by a store terminal disposed in a store, gives the customer points based on a result of measuring an action of the customer, and provides the customer with a service corresponding to the given points. In this manner, techniques for providing a service adapted to a user's interests and preferences are being contemplated.

### CITATION LIST

### Patent Literature

Patent Literature 1: Japanese Unexamined Patent Application Publication No. 2019-033360

Patent Literature 2: Japanese Unexamined Patent Application Publication No. 2015-153194

### SUMMARY OF INVENTION

### Technical Problem

According to Patent Literature 1 or 2, information about a user is acquired within a predetermined facility, and a service is provided based on the information about the user. Such a technique, however, does not anticipate a case of, based on information about a user acquired at a predetermined facility (e.g., first facility), providing a service concerning another facility (e.g., second facility). In order to further increase user satisfaction, there is a need to provide a service adapted to a user's interests and preferences and available at a plurality of facilities.

The present disclosure has been made to address such an issue and is directed to providing an information controlling apparatus, an information controlling method, and a computer-readable medium that each make it possible to provide a service adapted to a user's interests and preferences and available at a different facility as well.

### Solution to Problem

An information controlling apparatus according to the present disclosure includes:
a first registering unit configured to register registration information linking a predetermined user's biometric information and personal information;
an acquiring unit configured to acquire the biometric information of the user, in response to the user's entry into or exit from a first facility or the user's purchasing of a product or a service at the first facility;
a biometric authentication controlling unit configured to control, by use of the registration information, biometric authentication of the acquired biometric information of the user;
a second registering unit configured to, if the biometric authentication succeeds, register action information pertaining to the entry into or exit from the first facility or purchase information pertaining to the purchased product or service linked to the registration information of the user whose biometric authentication has succeeded;
a determining unit configured to determine, based on the registration information, a service suitable for the user and available at a second facility; and
a processing unit configured to perform a process pertaining to providing of the service.

An information controlling method according to the present disclosure includes:
executed by a computer, registering registration information linking a predetermined user's biometric information and personal information;
acquiring the biometric information of the user, in response to the user's entry into or exit from a first facility or the user's purchasing of a product or a service at the first facility;
controlling, by use of the registration information, biometric authentication of the acquired biometric information of the user;
if the biometric authentication succeeds, registering action information pertaining to the entry into or exit from the first facility or purchase information pertaining to the purchased product or service linked to the registration information of the user whose biometric authentication has succeeded;
determining, based on the registration information, a service suitable for the user and available at a second facility; and
performing a process pertaining to providing of the service.

A computer-readable medium according to the present disclosure is a non-transitory computer-readable medium storing a program that causes a computer to execute:
a step of registering registration information linking a predetermined user's biometric information and personal information;
a step of acquiring the biometric information of the user, in response to the user's entry into or exit from a first facility or the user's purchasing of a product or a service at the first facility;
a step of controlling, by use of the registration information, biometric authentication of the acquired biometric information of the user;
if the biometric authentication succeeds, a step of registering action information pertaining to the entry into or exit from the first facility or purchase information pertaining to the purchased product or service linked to the registration information of the user whose biometric authentication has succeeded;
a step of determining, based on the registration information, a service suitable for the user and available at a second facility; and
a step of performing a process pertaining to providing of the service.

### Advantageous Effects of Invention

The present disclosure can provide an information controlling apparatus, an information controlling method, and a computer-readable medium that each make it possible to provide a service adapted to a user's interests and preferences and available at a different facility as well.

### BRIEF DESCRIPTION OF DRAWINGS

FIG. 1 is a block diagram showing a configuration of an information controlling apparatus according to a first example embodiment.

FIG. 2 is a flowchart showing an information controlling method according to the first example embodiment.

FIG. 3 is a flowchart showing an information controlling method according to a second example embodiment.

FIG. 4 is a block diagram showing a configuration of an information controlling apparatus according to a third example embodiment.

FIG. 5 shows an example of evaluation information according to the third example embodiment.

FIG. 6 shows an example of evaluation information according to the third example embodiment.

FIG. 7 shows an example of evaluation information according to the third example embodiment.

FIG. 8 shows an example of evaluation information according to the third example embodiment.

FIG. 9 is a flowchart showing an information controlling method according to the third example embodiment.

FIG. 10 is a block diagram showing a configuration of an information controlling system according to a fourth example embodiment.

FIG. 11 is a block diagram showing a configuration of an authentication apparatus according to the fourth example embodiment.

FIG. 12 is a flowchart showing a process performed by the authentication apparatus according to the fourth example embodiment.

FIG. 13 is a flowchart showing a process performed by the authentication apparatus according to the fourth example embodiment.

FIG. 14 is a block diagram showing a configuration of an information controlling apparatus according to the fourth example embodiment.

FIG. 15 is a block diagram showing a configuration of a user terminal according to the fourth example embodiment.

FIG. 16 is a block diagram showing a configuration of a facility terminal according to the fourth example embodiment.

FIG. 17 shows an example of a display screen of a user terminal according to the fourth example embodiment.

FIG. 18 shows an example of a display screen of a user terminal according to the fourth example embodiment.

FIG. 19 shows an example of a display screen of a user terminal according to the fourth example embodiment.

FIG. 20 shows an example of a display screen of a user terminal according to the fourth example embodiment.

FIG. 21 shows an example of a display screen of a user terminal according to the fourth example embodiment.

### EXAMPLE EMBODIMENT

Hereinafter, some example embodiments of the present disclosure will be described in detail with reference to the drawings. In the drawings, identical or corresponding elements are given identical reference characters, and repetitive description thereof will be omitted as necessary for the clarity of description.

### First Example Embodiment

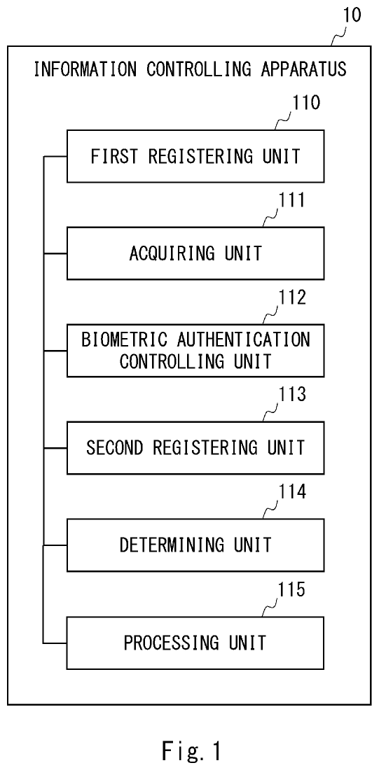

A configuration of an information controlling apparatus 10 will be described with reference to FIG. 1. FIG. 1 is a block diagram showing a configuration of the information controlling apparatus 10 according to a first example embodiment. Referring to FIG. 1, the information controlling apparatus includes a first registering unit 110, an acquiring unit 111, a biometric authentication controlling unit 112, a second registering unit 113, a determining unit 114, and a processing unit 115.

The information controlling apparatus 10 is a computer that can provide a service adapted to a user and available at a second facility, based on the user's registration information registered at a first facility. The information controlling apparatus 10 may be connected to a predetermined terminal or apparatus via a communication network (a communication network is also referred to below simply as a network) or via predetermined wireless communication. There is no limitation on whether a network is a wired network or a wireless network, nor is there any limitation on the type of a communication protocol. The terminal or the apparatus may be, for example, a user terminal, a facility terminal, an authentication apparatus, or a storage device. A user terminal is a terminal owned by a user and is, for example, a smartphone, a tablet, or the like.

The first registering unit 110 registers registration information linking a predetermined user's biometric information and personal information. The first registering unit 110 may register registration information into a storage device provided internal to the information controlling apparatus 10 or into a storage device provided external to the information controlling apparatus 10. Examples of what can be used as biometric information include facial feature information that can be acquired from a facial image as well as data (feature values) calculated from physical features unique to an individual, such as a pattern of one's fingerprint, voiceprint, vein, retina, or pupil's iris. The information controlling apparatus 10 may acquire biometric information for registration information from a user via a biometric information acquiring device, such as a camera.

Personal information may include, for example, a user's name, gender, date of birth, address, nationality, contact information (phone number, email address, social network service account, etc.), family structure, income information, or account information. Personal information may also include, for example, information about a sports team that a user is a fan of (supports) or information pertaining to a user's favorite sports.

The acquiring unit 111 acquires a user's biometric information in response to the user's entry into or exit from a first facility or the user's purchasing of a product or a service at a first facility. Examples of a facility include a stadium, a museum, or an art museum. In response to a user's entry into or exit from a first facility or a user's purchasing of a product or a service at a first facility, the acquiring unit 111 acquires the user's biometric information, for example, from a terminal provided at an entrance/exit gate of the first facility or at a store in the first facility (such a terminal is referred to below as a facility terminal).

A facility terminal is, for example, a computer provided at a first facility and can acquire a user's biometric information. For example, a facility terminal may be provided at an entrance/exit gate of a first facility, and the facility terminal may capture a user's facial image when the user enters or exits the first facility and may transmit the captured facial image to the acquiring unit 111. A facility terminal may be provided at a location other than an entrance/exit gate of a first facility and may acquire a user's facial image at a predetermined timing before or after the user enters or exits the first facility. Thus, the acquiring unit 111 can acquire, from a facility terminal, a user's facial image captured by the facility terminal.

In a similar manner, a facility terminal captures a user's facial image when the user purchases a product or a service within a first facility and transmits the captured facial image to the acquiring unit 111. Thus, the acquiring unit 111 can acquire a captured facial image of a user from a facility terminal. When a user purchases a product or a service may be before the user purchases a product or a service or after the user has purchased a product or a service or may be a predetermined timing.

Although it has been stated that a facility terminal captures a user's facial image, a facility terminal may acquire biometric information other than a facial image.

The acquiring unit 111 outputs a facial image acquired from a facility terminal to the biometric authentication controlling unit 112. The acquiring unit 111 may store a facial image acquired from a facility terminal into a storage device. In this case, the biometric authentication controlling unit 112 can acquire a facial image from the storage device.

The biometric authentication controlling unit 112 controls biometric authentication of acquired biometric information of a user, with use of registration information. Specifically, the biometric authentication controlling unit 112 transmits acquired biometric information to an authentication apparatus storing in advance facial feature information with use of registration information, and causes the authentication apparatus to perform biometric authentication. The authentication apparatus may be provided internal or external to the biometric authentication controlling unit 112. If the information controlling apparatus 10 includes the authentication apparatus described above, the biometric authentication controlling unit 112 performs a biometric authentication process by comparing biometric information. A detailed configuration of an authentication apparatus will be described later.

Instead of biometric authentication, identity proving authentication may be performed with use of predetermined identity proving information. Examples of identity proving information include Individual Number, a health insurance card, a passport, an ID/password combination, a two-dimensional bar code that can identify an individual, or an electronic certificate. Identity proving authentication is a method in which authentication is performed by comparing acquired identity proving information against identity proving information for use in authentication.

If biometric authentication succeeds, the second registering unit 113 registers action information pertaining to an entry into or exit from a first facility or purchase information pertaining to a purchased product or service linked to the registration information of the user whose biometric authentication has succeeded. For example, the second registering unit 113 registers action information pertaining to an entry into or exit from a first facility with the action information linked to the registration information of the user whose biometric authentication has succeeded. Herein, action information may be acquired by the acquiring unit 111 when the acquiring unit 111 acquires biometric information. In other words, a user's personal information and action information at a first facility are linked to each other and registered in the registration information. Herein, action information pertaining to an entry or exit is information indicating, for example, the number of times a user has entered or exited a first facility (the number of visits), the date and time of an entry or exit, or the duration of a stay.

In a similar manner, the second registering unit 113 registers purchase information pertaining to a product or a service that a user has purchased at a first facility with the purchase information linked to the registration information of the user whose biometric authentication has succeeded. Herein, purchase information may be acquired by the acquiring unit 111 when the acquiring unit 111 acquires biometric information. In other words, a user's personal information and purchase information at a first facility are linked to each other and registered in the registration information. Herein, purchase information pertaining to a product or a service is information indicating, for example, the content of a product or a service that a user has purchased at a first facility, the sum paid for that purchase, the date and time of a purchase, or the number of times purchase has been made.

The second registering unit 113 registers a user's action information or purchase information linked to the user's registration information and thus accumulates information pertaining to the user's interests and preferences.

The determining unit 114 determines a service suitable for a user and available at a second facility, based on registration information. For example, the determining unit 114 may determine, as a service, bonus information that can be used toward a payment made at a second facility. The determining unit 114 may determine to provide a user with a coupon for a specific team's goods redeemable at a second facility, based on purchase information pertaining to, for example, the specific team's goods, a product, that the user has purchased at a first facility. Alternatively, the determining unit 114 may determine to provide a user with a discount coupon for an entry into a second facility, based on information about the user's family structure and information about the number of times the user has visited a first facility. Thus, the determining unit 114 can provide a service personalized for each user.

A service that the determining unit 114 determines may include, for example, a service of informing a user of a result of a game of a team that the user is a fan of or sending a user information about an upcoming game of the team, based on the registration information. Thus, the information controlling apparatus 10 can further increase user satisfaction.

The processing unit 115 performs a process pertaining to providing of a service. For example, the processing unit 115 may send the content of a service to a user terminal, with use of the contact information included in the user's personal information registered in the registration information. If a user has visited a second facility, the processing unit 115 may display the content of a service on a signage equipped with a biometric authentication function and provided at the second facility. A signage equipped with a biometric authentication function is a device that includes a biometric authentication apparatus and that can display the content of a service for each user or provide a service to each user upon biometric authentication. For example, as a user undergoes biometric authentication with a signage equipped with a biometric authentication function, the user can find out the content of a service that the user can receive or acquire, for example, a coupon pertaining to a service.

The processing unit 115 may inform a user about a service at a predetermined timing. For example, the processing unit 115 may send a user terminal a notification of a service receivable at a second facility that the determining unit 114 has determined, while the user is at a first facility, or may send a user terminal a notification of a service receivable at a second facility that the determining unit 114 has determined, after the user has exited a first facility. The processing unit 115 may send a user terminal a notification of a service receivable at a second facility that the determining unit 114 has determined, while the user is at the second facility.

A second facility is a facility other than a first facility and is, for example, a stadium, a museum, or an art museum. For example, a user who likes watching sports may visit a plurality of stadiums to root for a team that the user is a fan of. In such a case, the information controlling apparatus 10 can provide a service suitable for the user and available at a second facility (e.g., a stadium), based on the registration information that includes the user's action information or purchase information at a first facility (e.g., another stadium).

As the information controlling apparatus 10 includes at least part of the configuration described above, the information controlling apparatus 10 can provide a service adapted to a user's interests and preferences and available at a different facility as well. Thus, the information controlling apparatus 10 can increase user satisfaction.

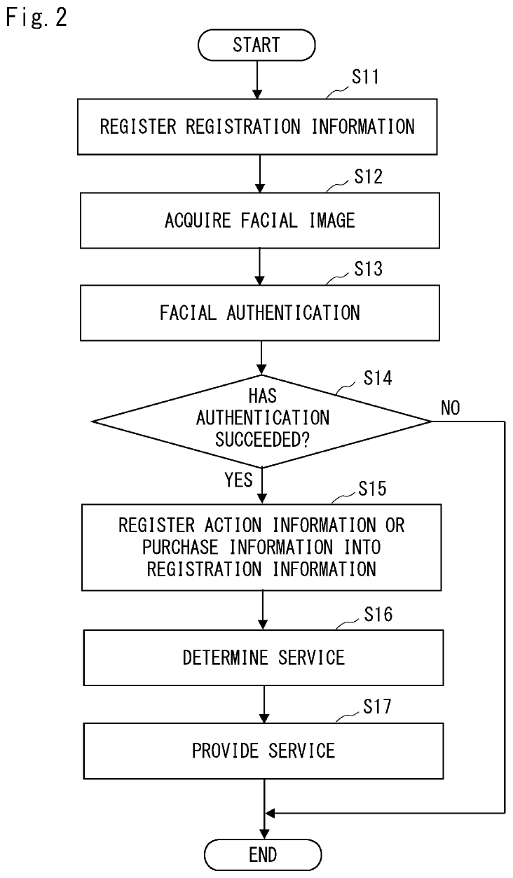

Next, a process that the information controlling apparatus 10 performs will be described with reference to FIG. 2. FIG. 2 is a flowchart showing an information controlling method performed by the information controlling apparatus 10 according to the first example embodiment. In the following description, for the brevity of description, biometric authentication is served by facial authentication, and biometric information is served by a facial image or facial feature information extracted from a facial image.

First, the first registering unit 110 of the information controlling apparatus registers registration information linking a user's facial image and personal information into a storage device (step S11). For example, the user transmits his or her own facial image and personal information to the information controlling apparatus 10 with use of a user terminal, and thus the user can register the biometric information and the personal information into the information controlling apparatus 10. For the facial image, facial image data included, for example, in an identity proving document, such as an Individual Number card or a passport, may be used. If the information controlling apparatus 10 is equipped with an imaging function, the user may capture his or her facial image with use of the imaging function of the information controlling apparatus 10 and may thus register the facial image into the information controlling apparatus 10. The user may input, with use of the user terminal, his or her personal information in a predetermined format provided by the information controlling apparatus 10 and may thus register the personal information into the information controlling apparatus 10. If the information controlling apparatus 10 is equipped with an input device, the user may register the personal information into the information controlling apparatus 10 with use of the input device.

It is not a limitation that biometric information (facial image or facial feature information) and personal information are linked to each other directly, and biometric information (facial image or facial feature information) and personal information may be linked to each other indirectly. For example, a first storage device internal to the information controlling apparatus 10 may register a user ID and personal information with the user ID and the personal information linked to each other, and a second storage device external to the information controlling apparatus 10 may register the user ID and biometric information with the user ID and the biometric information linked to each other. Herein, the second storage device may be an authentication apparatus. For example, the authentication apparatus extracts feature values from a user's facial image and acquires facial feature information. The authentication apparatus, for example, issues a user ID serving as the user's identification information and stores the user ID and the user's facial feature information with the user ID and the facial feature information linked to each other. Then, the first registering unit 110 may store the user ID issued by the authentication apparatus and the personal information into the first storage device with the user ID and the personal information linked to each other. Thus, the biometric information (facial image or facial feature information) and the personal information can be said to be linked to each other via the user ID. In the following, an example of facial authentication control performed with use of an authentication apparatus will be described.

The acquiring unit 111 acquires the user's facial image for biometric authentication, in response to the user's entry into or exit from a first facility or the user's purchasing of a product or a service at a first facility (step S12). The acquiring unit 111 acquires the user's facial image in response to the user's entry or exit or the user's purchasing of a product or a service, via a facility terminal provided at the first facility. Herein, the user's entry or exit may be managed by an entry and exit managing system that uses biometric authentication and is provided in the facility terminal. A product or a service may be purchased via a payment system that uses biometric authentication and is provided in the facility terminal.

The biometric authentication controlling unit 112 transmits the acquired facial image to an authentication apparatus and causes the authentication apparatus to perform facial authentication (step S13). Specifically, the biometric authentication controlling unit 112 transmits the acquired facial image to an authentication apparatus and requests the authentication apparatus to perform authentication. As described above, the authentication apparatus stores therein a plurality of users' identification information and facial feature information with the identification information and the facial feature information linked to each other. The authentication apparatus extracts predetermined feature values from the user's facial image acquired from the biometric authentication controlling unit 112 and compares the extracted feature values against the stored facial feature information. If the authentication succeeds, the authentication apparatus identifies the user and transmits the identification information of the identified user to the biometric authentication controlling unit 112 as an authentication result.

The biometric authentication controlling unit 112 determines whether the authentication has succeeded (step S14). The biometric authentication controlling unit 112 determines whether the authentication has succeeded, based, for example, on the authentication result received from the authentication apparatus. For example, if the authentication result indicates that the authentication has failed, the biometric authentication controlling unit 112 refrains from determining that the authentication has succeeded (step S14: NO). In this case, the information controlling apparatus 10 terminates the process.

Meanwhile, if the authentication result received from the authentication apparatus indicates that the authentication has succeeded, the biometric authentication controlling unit 112 determines that the authentication has succeeded (step S14: YES). If the authentication has succeeded, the second registering unit 113 registers action information pertaining to an entry into or exit from the first facility or purchase information pertaining to a purchased product or service linked to the registration information of the user whose biometric authentication has succeeded (step S15). Specifically, the second registering unit 113 registers the user ID identified by the biometric authentication and the action information or purchase information with the user ID and the action information or purchase information linked to each other. After the registration, the determining unit 114 determines a service suitable for the user and available at a second facility, based on the registration information of the user whose biometric authentication has succeeded (step S16). After the service has been determined, the processing unit 115 provides the service to the user (step S17). For example, the processing unit 115 refers to the user's contact information included in the registration information and provides, to the user terminal, a service that can be used at the second facility. Steps S12 to S15 may be performed repeatedly in response to the user's entry into or exit from the first facility or the user's purchasing of a product or a service at the first facility. The determining of a service at step S16 and the providing of the service at step S17 may each be performed a plurality of times independently of each other and may each be performed at a predetermined timing.

Thus far, the information controlling apparatus 10 according to the first example embodiment has been described. The information controlling apparatus includes, as its components, a processor, a memory, and a storage device (none illustrated). The storage device stores therein a computer program (also referred to below simply as a program) that implements the processes of the information controlling method according to the present example embodiment. The processor loads the computer program from the storage device onto the memory and executes the program. Thus, the processor implements the functions of the first registering unit 110, the acquiring unit 111, the biometric authentication controlling unit 112, the second registering unit 113, the determining unit 114, and the processing unit 115.

The components of the information controlling apparatus 10 may each be implemented by a dedicated piece of hardware. Part or the whole of each constituent element may be implemented by, for example, general-purpose or dedicated circuitry, a processor, or a combination thereof. Such constituent elements may be constituted by a single chip or by a plurality of chips connected via a bus. Part or the whole of each constituent element of the devices may be implemented by a combination of, for example, the circuitry described above and a program. For the processor, a central processing unit (CPU), a graphics processing unit (GPU), a field-programmable gate array (FPGA), a quantum processor (quantum computer control chip), or the like can be used.

If part or the whole of the constituent elements of the information controlling apparatus 10 is implemented by a plurality of information controlling apparatuses, circuitries, or the like, these information controlling apparatuses, circuitries, or the like may be disposed centrally or distributedly. For example, such information controlling apparatuses or circuitries may be implemented in a mode in which they are interconnected via a communication network, as in, for example, a client server system or a cloud computing system. The functions of the information controlling apparatus 10 may be provided in the form of Software as a Service (SaaS).

As described above, the information controlling apparatus 10 according to the first example embodiment can provide a service adapted to a user's interests and preferences and available at a second facility, with use of the user's action information or purchase information at a first facility. This can increase user satisfaction at facilities that the user uses. Furthermore, a managing organization, such as a stadium operating company, a baseball organization, or a soccer organization, providing a service to a user can, with use of the information controlling apparatus 10, increase the user's eagerness to visit a second facility or the user's eagerness to make a purchase at a second facility. Thus, in sports that have games at a plurality of stadiums, such as a baseball league or a soccer league, the league as a whole can be livened up through service cooperation between a plurality of stadiums. Since the information controlling apparatus 10 performs biometric authentication, this obviates the need that the user manages, for example, his or her ID or password, and thus the user can be kept from being tasked with too much of a burden.

The present example embodiment can provide an information controlling apparatus, an information controlling method, and a computer-readable medium that each make it possible to provide a service adapted to a user's interests and preferences and available at a different facility as well.

### Second Example Embodiment

An information controlling apparatus 10 according to a second example embodiment registers a user's action information or purchase information at a second facility with such action information or purchase information linked further to registration information that includes the user's action information or purchase information at a first facility. With use of such registration information, the information controlling apparatus 10 provides a service available at a second facility to a user whose biometric authentication has succeeded at the second facility. Thus, a service that is more adapted to a user's interests and preferences can be provided. A configuration of the information controlling apparatus 10 according to the second example embodiment is similar to the configuration of the information controlling apparatus 10 according to the first example embodiment shown in FIG. 1, and thus similar reference characters are used in the description. The following description centers on the differences from the first example embodiment, and detailed description of the content similar to that of the first example embodiment will be omitted as appropriate.

The acquiring unit 111 further acquires a user's biometric information in response to the user's entry into or exit from a second facility or the user's purchasing of a product or a service at a second facility. At this point, the acquiring unit 111 acquires a facial image serving as the user's biometric information in response to the user's entry or exit or the user's purchasing of a product or a service, via a facility terminal provided at the second facility. As in a first facility, in a second facility as well, a user's entry or exit may be managed by an entry and exit managing system that uses biometric authentication and is provided in a facility terminal, and a product or a service may be purchased via a payment system that uses biometric authentication and is provided in a facility terminal.

If biometric authentication at a second facility succeeds, the second registering unit 113 registers action information pertaining to an entry into or exit from the second facility or purchase information pertaining to a purchased product or service linked further to the registration information of the user whose biometric authentication has succeeded. Thus, the action information or the purchase information at the first and second facilities becomes registered in the registration information. The second registering unit 113 may store, into a storage device, action information or purchase information acquired at a first facility separately from action information or purchase information acquired at a second facility. The second registering unit 113 may register, into a storage device, registration information separately from each predetermined period.

Based on registration information, the determining unit 114 determines a service available at a second facility and suitable for a user whose biometric authentication at the second facility has succeeded. For example, action information indicating that a user has purchased a first team's goods at a first facility and has visited a second facility may be registered into the registration information. In this case, based on the registration information, the determining unit 114 may determine to provide the user with a coupon, as a service, redeemable for the first team's goods at the second facility.

Meanwhile, purchase information indicating that a user has purchased a first team's goods at a first facility and has purchased the first team's goods at a second facility as well may be registered in the registration information. In this case, since it is conceivable, based on the registration information, that the user supports the first team and is highly eager to purchase the first team's goods, the determining unit 114 may determine, based on the registration information, to provide a coupon, as a service, redeemable for the first team's goods at the second facility.

The processing unit 115 may, for example, send the content of a service to a user terminal, based on the contact information included in the user's personal information registered in the registration information. The processing unit 115 may display the content of a service on a signage equipped with a biometric authentication function and provided at a second facility.

Registration information may include action information or purchase information at a facility other than first and second facilities. For example, the second registering unit 113 may register a user's action information or purchase information at another facility with such action information or purchase information linked further to the registration information that includes action information or purchase information at first and second facilities. Thus, the information controlling apparatus 10 can provide a service suitable for a user and available at another facility and can increase user satisfaction. In other words, the information controlling apparatus 10 can further accumulate a user's action information or purchase information at a plurality of facilities and can provide a service suitable for the user and available at the plurality of facilities.

As described above, the information controlling apparatus 10 according to the second example embodiment can provide a service that is adapted to a user's interests and preferences and that is available at a second facility, based on the user's action information or purchase information at the second facility. As action information or purchase information at a facility other than first and second facilities is registered with such action information or purchase information linked further to registration information, a service suitable for a user and available at a plurality of facilities can be provided. Thus, the information controlling apparatus 10 can provide a service personalized for each user at a plurality of facilities and can thus improve user satisfaction.

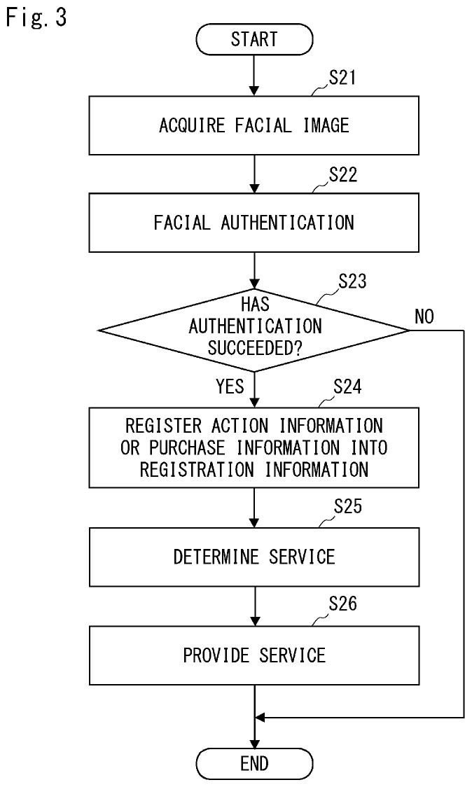

A process performed by the information controlling apparatus 10 according to the second example embodiment will be described below with reference to FIG. 3. FIG. 3 is a flowchart showing an information controlling method performed by the information controlling apparatus 10 according to the second example embodiment. Before step S21 of FIG. 3 starts, the user's biometric information and personal information and the user's action information or purchase information at the first facility are linked to each other and registered in the registration information.

The acquiring unit 111 further acquires the user's biometric information in response to the user's entry into or exit from a second facility or the user's purchasing of a product or a service at a second facility (step S21). The acquiring unit 111, for example, can acquire the user's facial image in response to the user's entry or exit or the user's purchasing of a product or a service, via a facility terminal provided at the second facility. The biometric authentication controlling unit 112 transmits the facial image acquired at the second facility to an authentication apparatus and causes the authentication apparatus to perform facial authentication (step S22). Specifically, the biometric authentication controlling unit 112 transmits the acquired facial image to the authentication apparatus and requests the authentication apparatus to perform authentication. As described above, the authentication apparatus stores therein a plurality of users' identification information and facial feature information with the identification information and the facial feature information linked to each other. The authentication apparatus extracts predetermined feature values from the user's facial image acquired from the biometric authentication controlling unit 112 and compares the extracted feature values against the stored facial feature information. If the authentication succeeds, the authentication apparatus identifies the user and transmits the identification information of the identified user to the biometric authentication controlling unit 112 as an authentication result.

The biometric authentication controlling unit 112 determines whether the authentication has succeeded (step S23). The biometric authentication controlling unit 112 determines whether the authentication has succeeded based, for example, on the authentication result received from the authentication apparatus. For example, if the authentication result indicates that the authentication has failed, the biometric authentication controlling unit 112 refrains from determining that the authentication has succeeded (step S23: NO). In this case, the information controlling apparatus 10 terminates the process.

Meanwhile, if the authentication result received from the authentication apparatus indicates that the authentication has succeeded, the biometric authentication controlling unit 112 determines that the authentication has succeeded (step S23: YES). If biometric authentication at the second facility has succeeded, the second registering unit 113 registers action information pertaining to an entry into or exit from the second facility or purchase information pertaining to a purchased product or service linked further to the registration information of the user whose biometric authentication has succeeded (step S24). Specifically, the second registering unit 113 registers the user ID identified by the biometric authentication and the user's action information or purchase information at the second facility with the user ID and the action information or purchase information linked to each other. After the registration, based on the registration information, the determining unit 114 determines a service available at the second facility and suitable for the user whose biometric authentication at the second facility has succeeded (step S25). After the service has been determined, the processing unit 115 provides the service to the user (step S26). For example, the processing unit 115 may refer to the user's contact information included in the registration information and provide the service available at the second facility to the user terminal at a predetermined timing.

As described above, the information controlling apparatus 10 according to the second example embodiment registers a user's action information or purchase information at a second facility with such action information or purchase information linked to registration information that includes the user's action information or purchase information at a first facility. Based on such registration information, the information controlling apparatus 10 can provide a service more suitable for the user and available at the second facility. The information controlling apparatus 10 can provide a service personalized for each user and can thus improve user satisfaction.

### Third Example Embodiment

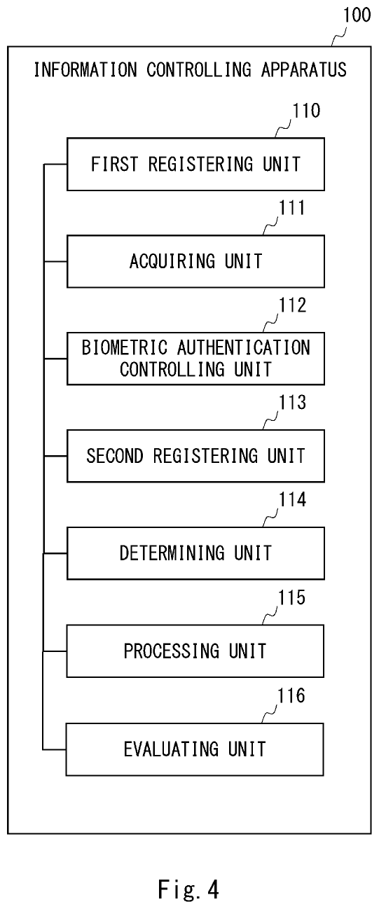

FIG. 4 is a block diagram showing a configuration of an information controlling apparatus 100 according to a third example embodiment. The information controlling apparatus 100 can evaluate a user based on action information or purchase information and can thus provide a service corresponding to the evaluation.

Referring to FIG. 4, the information controlling apparatus 100 includes a first registering unit 110, an acquiring unit 111, a biometric authentication controlling unit 112, a second registering unit 113, a determining unit 114, a processing unit 115, and an evaluating unit 116. Of the components of the information controlling apparatus 100 according to the third example embodiment, the first registering unit 110, the acquiring unit 111, the biometric authentication controlling unit 112, the second registering unit 113, the determining unit 114, and the processing unit 115 are similar to those according to the first or second example embodiment, and thus, with similar reference characters given to these components, detailed description thereof will be omitted as appropriate. The following description centers on the differences from the first example embodiment.

The evaluating unit 116 evaluates a user based on action information and purchase information. For example, the evaluating unit 116 may evaluate a user based on the number of times the user has visited a predetermined facility within a predetermined period and the sum paid for a product or a service the user has purchased at a predetermined facility within a predetermined period. In other words, in evaluation, the evaluating unit 116 may give a user higher points as the number of times the user has visited a first facility is higher. In a similar manner, in evaluation, the evaluating unit 116 may give a user higher points as the sum paid for a product or a service that the user has purchased at a first facility is higher. The evaluating unit 116 can evaluate a user based on action information and purchase information not only at a first facility but also at a second facility or at another facility. The method with which the evaluating unit 116 evaluates a user can be set as appropriate by a personnel managing the information controlling apparatus 100.

The evaluating unit 116 may evaluate a user based on information about a ticket that the user has purchased to visit a predetermined facility. In this case, in evaluation, the evaluating unit 116 may give higher points to a user having a higher-priced ticket. Information about the price or the like of a ticket that the user has purchased may be acquired by the acquiring unit 111 via a facility terminal. In evaluation, the evaluating unit 116 may give higher points to a user whose sum paid for purchase at each of a plurality of facilities is higher than a predetermined sum. The evaluating unit 116 may evaluate a user based on the number of times the user has visited the home stadium of a team that the user supports or the number of times the user has visited an away stadium, with use of the personal information included in the user's registration information. For example, in order to increase a user's eagerness to visit an away stadium, the evaluating unit 116 may increase the number of points to be given to the user as the number of times the user visits an away stadium is higher. The evaluating unit 116 may give high points to a user who has purchased a specific product or service.

The evaluating unit 116 may classify a user according to his or her points. For example, in evaluation criterion for classification, the evaluating unit 116 may classify a user to Class 1 if the number of points given to the user is no higher than 10, classify a user to Class 2 if the number of points given to the user is from 10 to 100, or classify a user to Class 3 if the number of points given to the user is no lower than 100.

The second registering unit 113 registers evaluation information pertaining to evaluation with the evaluation information linked to the registration information of the user whose biometric authentication has succeeded. Evaluation information includes, for example, information indicating the total number of points given to a user or the class of a user. The second registering unit 113 may register, into registration information, points that are based on a user's action information separately from points that are based on the user's purchase information.

FIG. 5 shows an example of evaluation information made by the evaluating unit 116. For example, the evaluating unit 116 may give a user one point as a visit point for each visit or give a user one point as a purchase point for every 1,000 yen spent on purchase. Such evaluation criteria can be set as appropriate by a personnel managing the information controlling apparatus 100. For example, for a specific product or service at a predetermined facility, the evaluating unit 116 may give a user five points as special points each time the user purchases the specific product or service. A user may use received points toward a payment.

The user with the user ID 1 has been given 30 points as visit points for the number of times the user has visited the first facility and has been given 50 points as purchase points for the sum paid for purchase. Furthermore, the user with the user ID 1 has been given 10 points as visit points for the number of times the user has visited the second facility and has been given 20 points as purchase points for the sum paid for purchase. Thus, the total points of the user with the user ID 1 are 110 points, and this user is classified into Class 3 according to an evaluation criterion for classification described above. Although FIG. 5 shows evaluation information at the first and second facilities for simplifying the description, evaluation information at a facility other than the first and second facilities may also be included.

In a similar manner, the user with the user ID 2 has been given five points as visit points for the number of times the user has visited the first facility and has been given ten points as purchase points for the sum paid for purchase. Furthermore, the user with the user ID 2 has been given two points as visit points for the number of times the user has visited the second facility and has been given four points as purchase points for the sum paid for purchase. Thus, the total points of the user with the user ID 2 are 21 points, and this user is classified into Class 2 according to an evaluation criterion for classification described above.

In a similar manner, the user with the user ID 3 has been given one point as a visit point for the number of times the user has visited the first facility and has been given zero points as purchase points for the sum paid for purchase. Furthermore, the user with the user ID 2 has zero points as visit points for the number of times the user has visited the second facility and has zero points as purchase points for the sum paid for purchase. Thus, the total point of the user with the user ID 3 is one point, and this user is classified into Class 1 according to an evaluation criterion for classification described above.

The number of users is not limited to the number indicated above. A user who has merely registered registration information and has no action information or purchase information at any facility has a total point of zero points, and thus such a user may be classified as No Class.

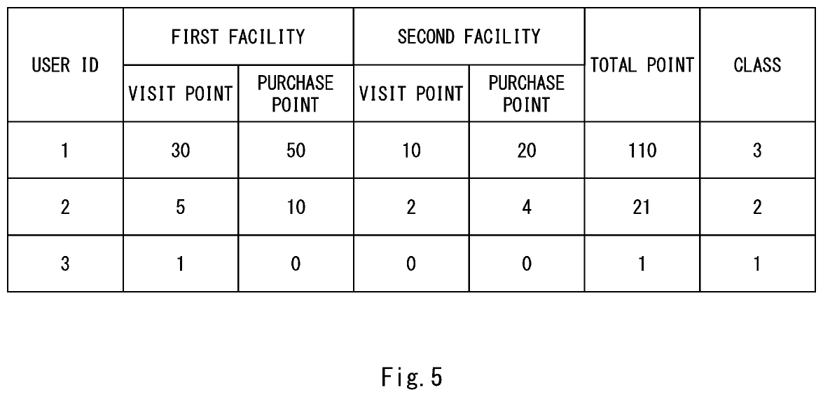

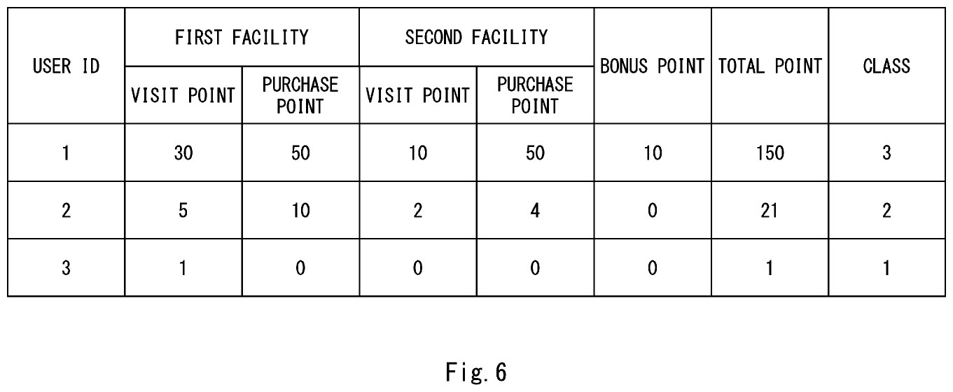

FIG. 6 shows an example of evaluation information made by the evaluating unit 116. The evaluating unit 116 may give a bonus point to a user whose sum paid for purchase at each of the first and second facilities is no lower than a predetermined sum and may thus evaluate such a user highly. For example, referring to FIG. 6, the evaluating unit 116 may give 10 bonus points to the user with the user ID 1, who has 50 or more purchase points for the sum paid for purchase at each of the first and second facilities. This can increase a user's eagerness to make a purchase.

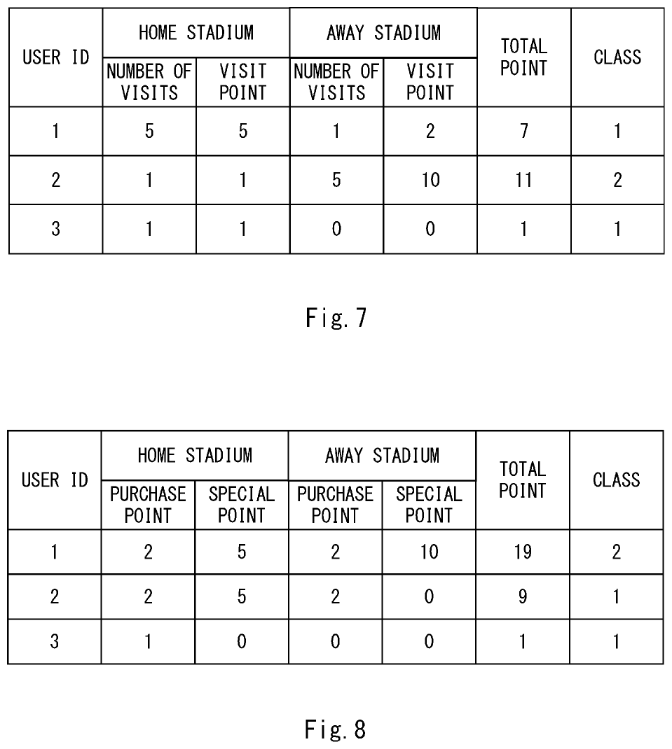

FIG. 7 shows an example of evaluation information made by the evaluating unit 116. The evaluating unit 116 may evaluate a user based on the number of times the user has visited the home stadium of a team that the user supports or the number of times the user has visited an away stadium. For example, in order to increase a user's eagerness to visit an away stadium, the evaluating unit 116 may give higher points as the number of times the user has visited an away stadium is higher. Referring to FIG. 7, in evaluation of a user, the evaluating unit 116 gives one point as a visit point for each visit to the home stadium and gives two points as visit points for each visit to an away stadium. For the brevity of description, description regarding purchase points is omitted in reference to FIG. 7, but purchase points may also be given to a user in a similar manner to those shown in, for example, FIG. 5 or 6. The user with the user ID 1 has visited the home stadium five times and has thus been given five points as visit points to the home stadium. Meanwhile, the user with the user ID 1 has visited an away stadium once and has thus been given two points as visit points to the away stadium. The total points of the user with the user ID 1 are seven points, and this user is classified to Class 1 according to an evaluation criterion described above.

Meanwhile, the user with the user ID 2 has visited the home stadium once and has thus been given one point as a visit point to the home stadium. The user with the user ID 2 has visited an away stadium five times and has thus been given ten points as visit points to the away stadium. The total points of the user with the user ID 2 are 11 points, and this user is classified to Class 2 according to an evaluation criterion described above. In other words, the user with the user ID 1 and the user with the user ID 2 have visited the home stadium and the away stadium the same number of times, but the user with the user ID 2, who has visited an away stadium more times than the user with the user ID 1 has, is classified into Class 2 and evaluated more highly. In this manner, the evaluating unit 116 gives higher points as the number of times a user visits an away stadium is higher and thus can increase the user's eagerness to visit an away stadium.

FIG. 8 shows an example of evaluation information made by the evaluating unit 116. The evaluating unit 116 may give higher points to a user who has purchased a specific product or service. For example, if a user has purchased a specific product or service, the evaluating unit 116 gives the user five points as special points, in addition to the purchase points corresponding to the sum paid for purchase, each time the user purchases one specific product or service. For the brevity of description, description regarding visit points is omitted in reference to FIG. 8, but visit points may also be given in a similar manner to those shown in, for example, FIG. 5 or 6.

Referring to FIG. 8, the user with the user ID 1 has purchased one specific product or service at the home stadium and has thus been given five points as special points. Furthermore, the user with the user ID 1 has purchased two specific products or services at an away stadium and has thus been given 10 points as special points. Thus, the user with the user ID 1 has been given a total of 19 points and is classified into Class 2 according to an evaluation criterion described above.

Meanwhile, the user with the user ID 2 has purchased one specific product or service at the home stadium and has thus been given five points as special points. However, the user with the user ID 2 has not purchased any of the specific products or services at an away stadium and thus has zero special points. Thus, the user with the user ID 2 has been given a total of nine points and is classified into Class 1 according to an evaluation criterion described above. In other words, a user is given a special point and evaluated more highly as the user purchases a specific product or service. This, therefore, can increase a user's eagerness to purchase a specific product or service.

The determining unit 114 determines a service based on evaluation information in registration information. For example, the determining unit 114 may change the content of a service to be provided in accordance with a user's class. For example, referring to FIG. 5, the determining unit 114 may provide a service of a higher grade to the user with the user ID 1 classified to Class 3 than a service to be provided to a user of Class 1 or Class 2. The determining unit 114 may provide a service of a higher grade to the user with the user ID 2 classified to Class 2 than a service to be provided to a user of Class 1. Examples of such a service of a higher grade include a coupon with a higher discount rate or a priority purchase service for a ticket to enter a facility.

As described above, the information controlling apparatus 100 according to the third example embodiment can change the service to be provided based on evaluation information of a user. For example, a user is evaluated more highly as the number of times the user has visited a facility is higher or as the sum paid for purchase at a facility is higher and can receive a service corresponding to the evaluation. Thus, the information controlling apparatus 100 can increase a user's eagerness to visit a facility or to purchase a product or a service and can also increase user satisfaction.

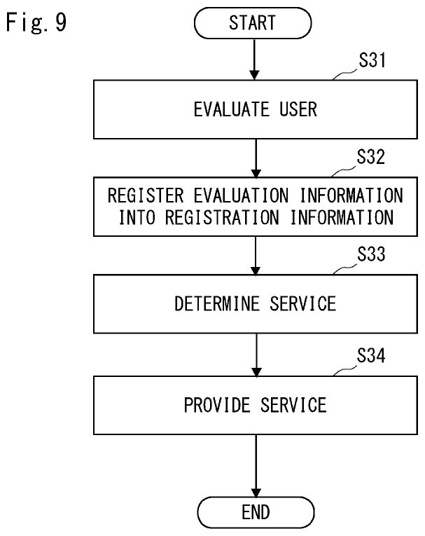

A process performed by the information controlling apparatus 100 according to the third example embodiment will be described below with reference to FIG. 9. FIG. 9 is a flowchart showing an information controlling method performed by the information controlling apparatus 100 according to the third example embodiment. In the information controlling apparatus 100 according to the third example embodiment, a process of registering action information or purchase information at a first facility into registration information and a process of registering action information or purchase information at a second facility into the registration information are similar to the processes performed by the information controlling apparatus 10 according to the first or second example embodiment, and thus description thereof will be omitted. In other words, before step S31 of FIG. 9 starts, the user's biometric information and personal information and the user's action information or purchase information at the first facility are registered with these pieces of information linked to each other and registered into the registration information. Furthermore, the registration information may be registered with the registration information linked to the action information or the purchase information at the second facility.

The evaluating unit 116 evaluates the user based on the action information and the purchase information (step S31). Specifically, the evaluating unit 116 evaluates the user based on the user's action information and purchase information at the first facility. If the user has visited the second facility, the evaluating unit 116 evaluates the user based on the user's action information and purchase information at the first and second facilities. As shown in FIGS. 5 to 8, for example, the evaluating unit 116 may give the user points based on the number of times the user has visited a facility or the sum the user has paid for purchase and may evaluate the user by classifying the user.

The second registering unit 113 registers evaluation information pertaining to the evaluation with the evaluation information linked to the registration information of the user whose biometric authentication has succeeded (step S32). The determining unit 114 determines a service based on the evaluation information in the registration information (step S33). Specifically, the determining unit 114 may determine the content of a service in accordance with the user's class evaluated by the evaluating unit 116. For example, the determining unit 114 may provide the user with a service of a higher grade as the user's class is higher. The determining unit 114 may provide a service of a lesser grade as the user's class is lower.

After the service has been determined, the processing unit 115 provides the service to the user (step S34). For example, the processing unit 115 may refer to the user's contact information included in the registration information and provide the service available at the second facility to the user terminal at a predetermined timing.

As described above, the information controlling apparatus 100 according to the third example embodiment can change the service to be provided based on a user's evaluation information. A user is evaluated more highly as the number of times the user has visited a facility is higher or as the sum paid for purchase at a facility is higher and can receive a service corresponding to the evaluation. Thus, the information controlling apparatus 100 can increase a user's eagerness to visit a facility or to purchase a product or a service and can also increase user satisfaction.

### Fourth Example Embodiment

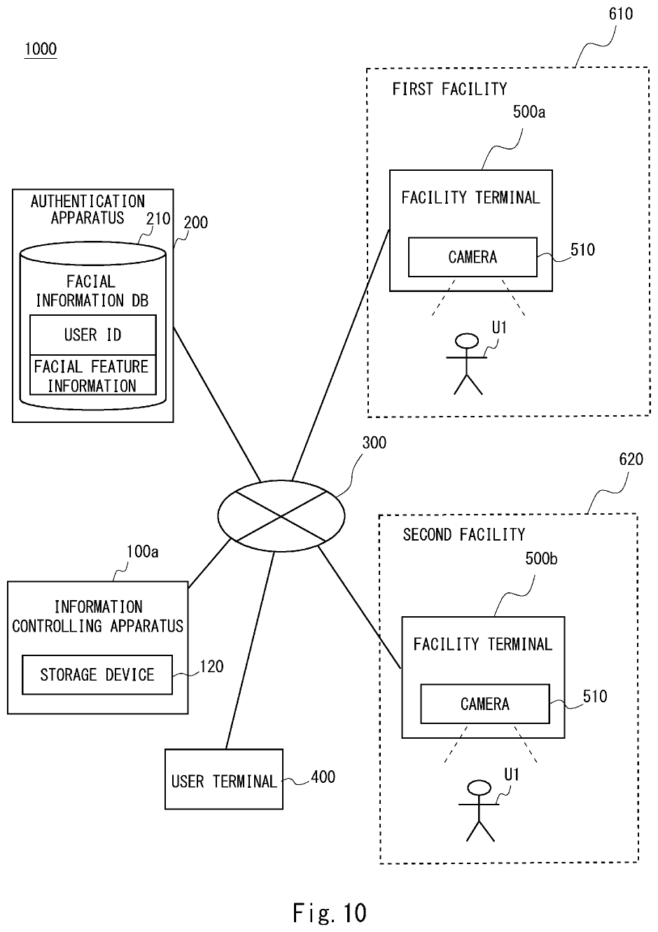

A fourth example embodiment is a specific example of the first, second, or third example embodiment described above. FIG. 10 is a block diagram showing an overall configuration of an information controlling system 1000 according to the fourth example embodiment. The information controlling system 1000 includes an information controlling apparatus 100a, an authentication apparatus 200, a user terminal 400, a facility terminal 500a, and a facility terminal 500b. The information controlling apparatus 100a, the authentication apparatus 200, the user terminal 400, the facility terminal 500a, and the facility terminal 500b are connected to each other via a network 300. The facility terminal 500a is provided at a first facility 610, and the facility terminal 500b is provided at a second facility 620. The information controlling apparatus 100a is an information controlling apparatus that registers action information or purchase information of a user U1 acquired by the facility terminal 500a at the first facility 610 linked to registration information and, based on the registration information, provides a service suitable for the user U1 and available at the second facility 620. According to the present example embodiment, the information controlling apparatus 100a includes a storage device 120. Any description that is repetitive of the description of the first, second, or third example embodiment will be omitted as appropriate. For the brevity of description, the facility terminal 500a and the facility terminal 500b may be collectively referred to as a facility terminal 500.

The network 300 is a wired or wireless communication circuit and is, for example, the internet. The user terminal 400 is a terminal owned by the user U1 and is, for example, a smartphone or a tablet. The facility terminal 500 (facility terminals 500a, 500b, and the like) is a terminal device that can be installed at the first facility 610, the second facility 620, or any other facility, and a plurality of facility terminals 500 may be installed at each predetermined facility. For example, the facility terminal 500 may be installed at an entrance/exit gate of a facility or at a location where a product or a service can be purchased within a facility. The facility terminal 500 is a computer having, for example, a communication function, a storage device, a computation device, or an imaging function. The facility terminal 500 may have a payment settling function using biometric authentication. The facility terminal 500 captures a user's facial image in response to the user's entry or exit or the user's purchasing of a product or a service and transmits the captured facial image of the user to the acquiring unit 111 of the information controlling apparatus 100a.

The authentication apparatus 200 stores therein facial feature information of a plurality of users including the user UI and user IDs serving as identification information of the users with the facial feature information and the user IDs linked to each other. In response to a facial authentication request received from the outside, the authentication apparatus 200 acquires facial feature information with use of a facial image included in the received request, compares the acquired facial feature information against facial feature information of each user, and returns an authentication result served by the comparison result to the requester.

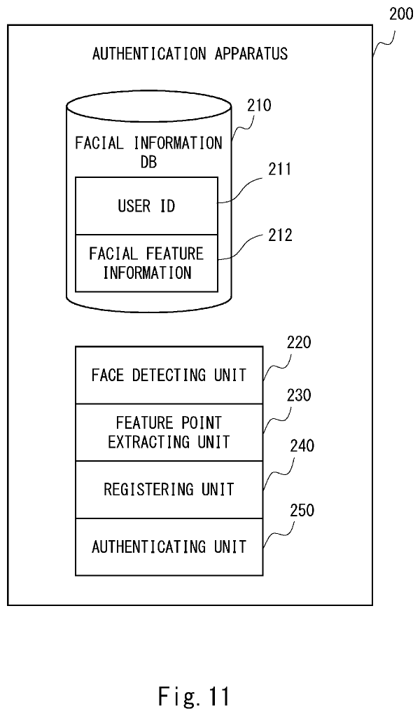

FIG. 11 is a block diagram showing a configuration of the authentication apparatus 200 according to the fourth example embodiment. The authentication apparatus 200 includes a facial information database (DB) 210, a face detecting unit 220, a feature point extracting unit 230, a registering unit 240, and an authenticating unit 250. The facial information DB 210 stores a user ID 211 and facial feature information 212 of the user ID with the user ID 211 and the facial feature information 212 linked to each other. The facial feature information 212 is a set of feature points extracted from a facial image. The authentication apparatus 200 may delete a user's facial feature information 212 in the facial information DB 210 in response to a request from the user. Alternatively, the authentication apparatus 200 may delete facial feature information 212 in the facial information DB 210 after a predefined period has passed from the registration of the facial feature information 212.

The face detecting unit 220 detects a face region included in a facial image for registration received from the information controlling apparatus 100a and outputs the detected face region to the feature point extracting unit 230. The feature point extracting unit 230 extracts feature points from the face region detected by the face detecting unit 220 and outputs facial feature information to the registering unit 240. The registering unit 240 issues a new user ID 211 when registering facial feature information. The registering unit 240 registers the issued user ID 211 and the facial feature information 212 extracted from the facial image into the facial information DB 210 with the user ID 211 and the facial feature information 212 linked to each other. The registering unit 240 sends the issued user ID 211 to the information controlling apparatus 100a. Next, the face detecting unit 220 detects a face region included in a facial image for biometric authentication received from the information controlling apparatus 100a and outputs the detected face region to the feature point extracting unit 230. A facial image for biometric authentication is a facial image that the acquiring unit 111 acquires to perform biometric authentication after the user ID 211 has been issued. The feature point extracting unit 230 extracts feature points included in the received facial image and outputs facial feature information to the authenticating unit 250. The authenticating unit 250 performs facial authentication with use of the facial feature information 212. Specifically, the authenticating unit 250 compares the facial feature information extracted from the facial image against the facial feature information 212 in the facial information DB 210. If the comparison succeeds, the authenticating unit 250 identifies the user ID 211 linked to the facial feature information 212 against which the extracted facial feature information has been compared. The authenticating unit 250 returns the presence or absence of a match with the facial feature information to the requester as a facial authentication result. The presence or absence of a match with the facial feature information corresponds to the success or failure of the authentication. That facial feature information has a match means that the degree of match is no lower than a threshold. If facial authentication has succeeded, the facial authentication result includes the identified user ID 211.

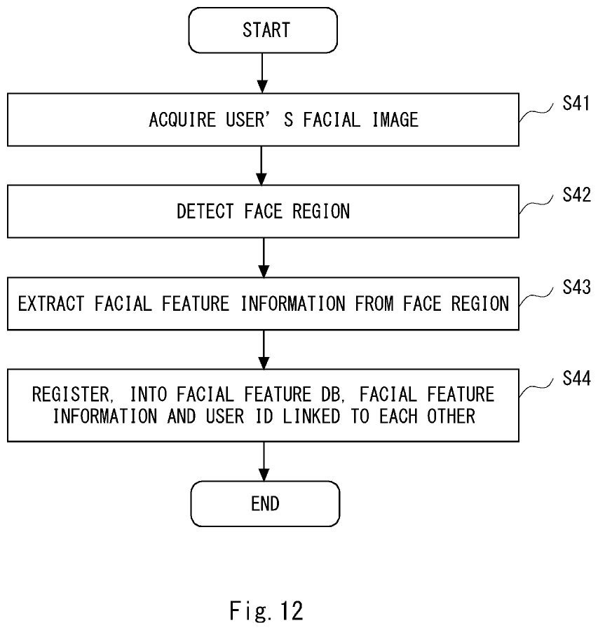

FIG. 12 is a flowchart showing a process performed by the authentication apparatus according to the fourth example embodiment. Herein, an information registering terminal (not illustrated) captures an image of a user's body including the user's face and transmits a facial information registration request including the captured facial image to the authentication apparatus 200 via the network 300. The information registering terminal may be, for example, an information processing device, such as a personal computer, a smartphone, or a tablet terminal. For example, the information registering terminal may be the user terminal 400 or the information controlling apparatus 100a that has received a facial information registration request from the user terminal 400.

First, the authentication apparatus 200 acquires a user's facial image for registration included in a facial information registration request (step S41). For example, the authentication apparatus 200 receives a facial information registration request from an information registering terminal via the network 300. Next, the face detecting unit 220 detects a face region included in the facial image (step S42). Next, the feature point extracting unit 230 extracts feature points from the face region detected at step S42 and outputs facial feature information to the registering unit 240 (step S43). Lastly, the registering unit 240 issues a user ID 211 and registers the user ID 211 and the facial feature information 212 into the facial information DB 210 with the user ID 211 and the facial feature information 212 linked to each other (step S44). The authentication apparatus 200 may receive the facial feature information 212 from the information registering terminal and register the facial feature information 212 into the facial information DB 210 with the facial feature information 212 linked to the user ID 211. The registering unit 240 may send the registered (issued) user ID 211 to the information registering terminal or the information controlling apparatus 100a.

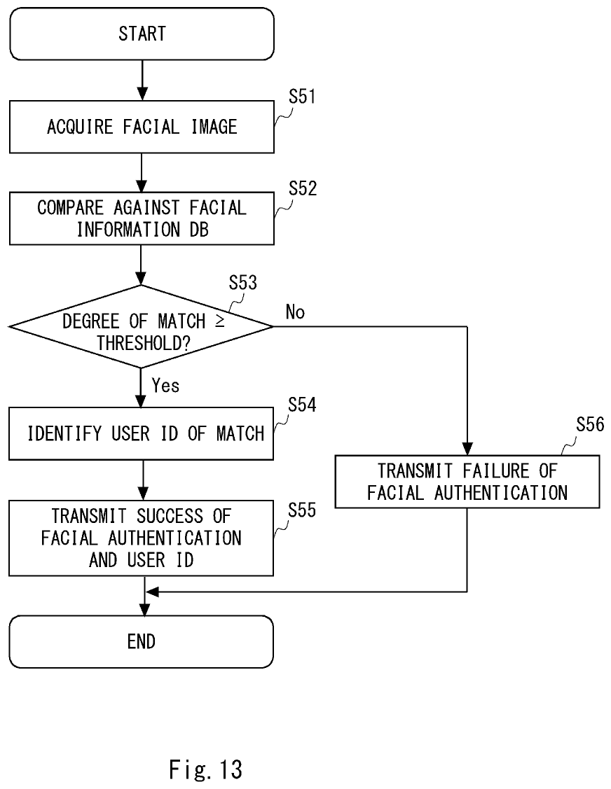

FIG. 13 is a flowchart showing an authentication process performed by the authentication apparatus 200 according to the fourth example embodiment. First, the feature point extracting unit 230 acquires a facial image for biometric authentication included in a facial authentication request (step S51). For example, the authentication apparatus 200 receives a facial authentication request from the information controlling apparatus 100a via the network 300 and extracts facial feature information from a facial image included in the facial authentication request as in steps S41 to S43. Alternatively, the authentication apparatus 200 may receive facial feature information from the information controlling apparatus 100a.

Next, the authenticating unit 250 compares the acquired facial feature information against the facial feature information 212 in the facial information DB 210 (step S52). If the facial feature information has a match, that is, if the degree of match of the facial feature information is no lower than a threshold (step S53: Yes), the authenticating unit 250 identifies the user ID 211 of the user whose facial feature information has been a match for the acquired facial feature information (step S54). The authenticating unit 250 transmits the fact that the facial authentication has succeeded and the identified user ID 211 to the information controlling apparatus 100a (step S55). if no facial feature information has matched (step S53: No), the authenticating unit 250 returns the fact that the facial authentication has failed to the information controlling apparatus 100a (step S56).

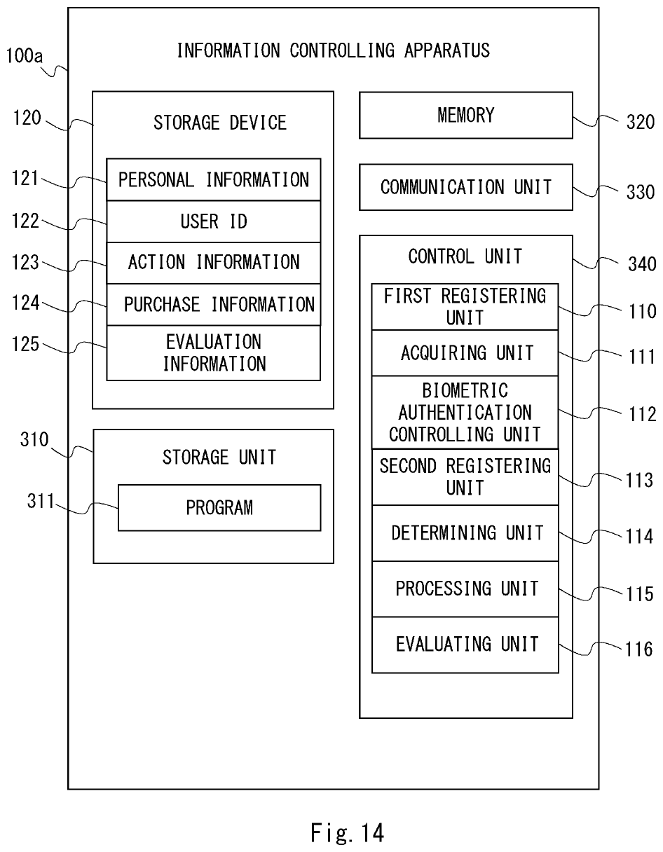

A configuration of the information controlling apparatus 100a will be described in detail. FIG. 14 is a block diagram showing a detailed configuration of the information controlling apparatus 100a according to the fourth example embodiment. The information controlling apparatus 100a includes a storage device 120, a storage unit 310, a memory 320, a communication unit 330, and a control unit 340. The information controlling apparatus 100a may have backup redundancy in a plurality of servers, and each functional block may be implemented by a plurality of computers.

The storage device 120 is a storage device, such as a hard disk or a flash memory. The storage device 120 stores therein a user's personal information 121, user ID 122, action information 123, purchase information 124, and evaluation information 125. The user ID 122 is one example of a user's identification information and is information corresponding to the user ID 211 in the facial information DB 210 of the authentication apparatus 200 described above. The user ID 122 may be linked to the user ID 211 and may be the same as or different from the user ID 211. Therefore, the facial feature information 212 (biometric information) in the facial information DB 210 of the authentication apparatus 200, the personal information 121, the action information 123, the purchase information 124, and the evaluation information 125 are linked to each other via the user ID, and these pieces of information can be regarded collectively as registration information described above.

The storage device 120 stores therein the user ID 122, the personal information 121, the action information 123, the purchase information 124, and the evaluation information 125 with these pieces of information linked to each other. In response to receiving, from the information controlling apparatus 100a, a signal that includes the user ID 122 and that requests for the personal information 121, the action information 123, the purchase information 124, or the evaluation information 125 corresponding to the user ID 122, the storage device 120 outputs the personal information 121, the action information 123, the purchase information 124, or the evaluation information 125 corresponding to the user ID 122 to the information controlling apparatus 100a.

The storage unit 310 is one example of a storage medium, such as a hard disk or a flash memory. The storage unit 310 stores therein a program 311. The program 311 is a computer program implementing the process of the information controlling method according to the third example embodiment.

The memory 320 is a volatile storage device, such as a random-access memory (RAM), and is a storage area for temporarily holding information while the control unit 340 operates. The communication unit 330 is a communication interface with the network 300.

The control unit 340 is a processor that controls each component of the information controlling apparatus 100a, that is, is a control device. The control unit 340 loads the program 311 from the storage unit 310 onto the memory 320 and executes the program 311. Thus, the control unit 340 implements the functions of the first registering unit 110, the acquiring unit 111, the biometric authentication controlling unit 112, the second registering unit 113, the determining unit 114, the processing unit 115, and the evaluating unit 116 according to the first, second, or third example embodiment described above.

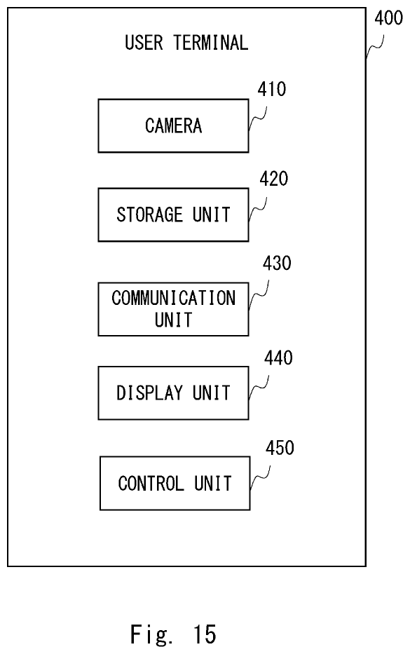

FIG. 15 is a block diagram showing a configuration of the user terminal 400 according to the fourth example embodiment. The user terminal 400 includes a camera 410, a storage unit 420, a communication unit 430, an input/output unit 440, and a control unit 450.

The camera 410 captures an image of the user U1 in response to the control of the control unit 450. The storage unit 420 is a storage device storing an (application) program for implementing each function of the user terminal 400. The communication unit 430 is a communication interface with the network 300. The input/output unit 440 includes a display device and an input device. The input/output unit 440 is, for example, a touch panel. The control unit 450 controls hardware of the user terminal 400. The control unit 450 loads a program from the storage unit 420 onto a memory and executes the program. Thus, the control unit 450 implements the functions of controlling the camera 410, the storage unit 420, the communication unit 430, and the input/output unit 440. A user can register biometric information and personal information into the information controlling apparatus 100a as registration information with use of the user terminal 400. The user can receive a service from the information controlling apparatus 100a via the user terminal 400.

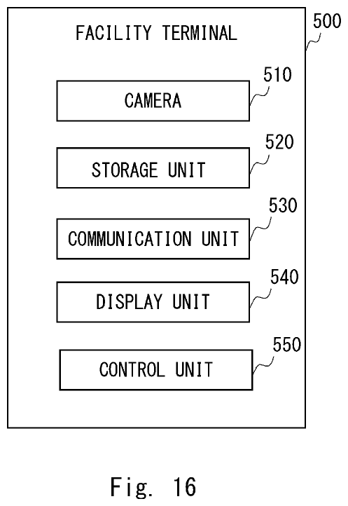

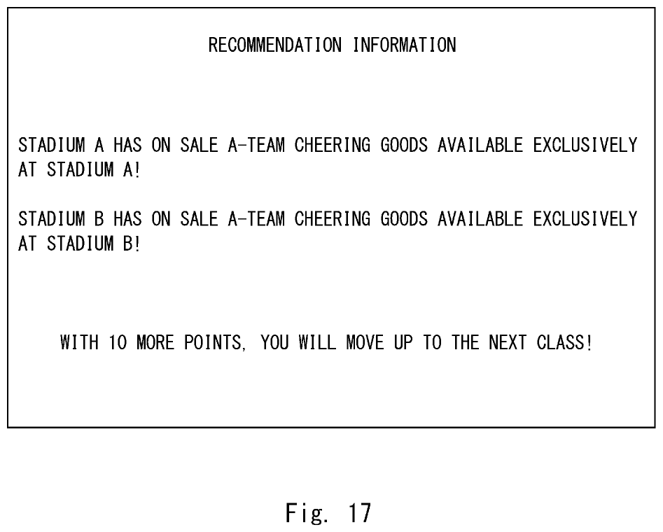

FIG. 16 is a block diagram showing a configuration of a facility terminal 500 according to the fourth example embodiment. The facility terminal 500 includes a camera 510, a storage unit 520, a communication unit 530, an input/output unit 540, and a control unit 550.

The camera 510 captures an image of the user U1 in response to the control of the control unit 550. The storage unit 520 is a storage device storing an (application) program for implementing each function of the facility terminal 500. The communication unit 530 is a communication interface with the network 300. The input/output unit 540 includes a display device and an input device. The input/output unit 540 is, for example, a touch panel. The control unit 550 controls hardware of the facility terminal 500. The control unit 550 loads a program from the storage unit 520 onto a memory and executes the program. Thus, the control unit 550 implements the functions of controlling the camera 510, the storage unit 520, the communication unit 530, and the input/output unit 540.

The facility terminal 500 may have the functions of the authentication apparatus 200. The facility terminal 500 may have a function pertaining to a payment system using biometric authentication. In this case, the facility terminal 500 may capture a user's facial image and perform biometric authentication when the user purchases a product or a service within a predetermined facility, and if the user's biometric authentication succeeds, the facility terminal 500 may settle the payment for the product or the service that the user has purchased, with use of account information of the personal information included in the registration information. Thus, the facility terminal 500 can acquire the user's facial image and purchase information pertaining to the product or the service that the user has purchased and transmit the facial image and the purchase information to the acquiring unit 111. Purchase information pertaining to a purchase of a product or a service may be input to the facility terminal 500 by a staff member using the facility terminal 500. The facility terminal 500 may be connected to, for example, a cash register provided in a store and receive an input of purchase information from the cash register.

The facility terminal 500 may be provided at an entrance/exit gate of a facility and may have a function of managing a user's entry or exit with use of biometric authentication. Specifically, the facility terminal 500 may capture a user's facial image and perform biometric authentication and may manage the user's entry and exit by controlling and opening the entrance/exit gate if the user's biometric authentication has succeeded. Thus, the facility terminal 500 can acquire a user's facial image and action information pertaining to the user's entry or exit and transmit the facial image and the action information to the acquiring unit 111.

FIG. 17 shows an example of a screen displayed on the user terminal 400. The user terminal 400 can acquire information pertaining to a service from the information controlling apparatus 100a with use of a predetermined application. With use of this application, the user terminal 400 can display information pertaining to a service on a screen of the user terminal 400. The user terminal 400 may request information that the user terminal 400 wants to acquire from the information controlling apparatus 100a.

As shown in FIG. 17, for example, recommendation information for the user may be displayed on the screen of the user terminal 400. For example, in accordance with the user's purchase information or class, a product available exclusively at each stadium (limited product) may be recommended. In FIG. 17, for example, the display screen displays “Stadium A has on sale A-team cheering goods available exclusively at Stadium A!” and “Stadium B has on sale A-team cheering goods available exclusively at Stadium B!” The display screen may also display how many additional points the user needs to acquire to move up to the next class. For example, in FIG. 17, “With 10 more points, you will move up to the next class” is displayed. The user can find out sales information of limited products at each stadium and can also find out how many points the user needs to acquire to move up to the next class. Thus, the information controlling apparatus 100a can increase a user's eagerness to visit a stadium or to make a purchase at a stadium.

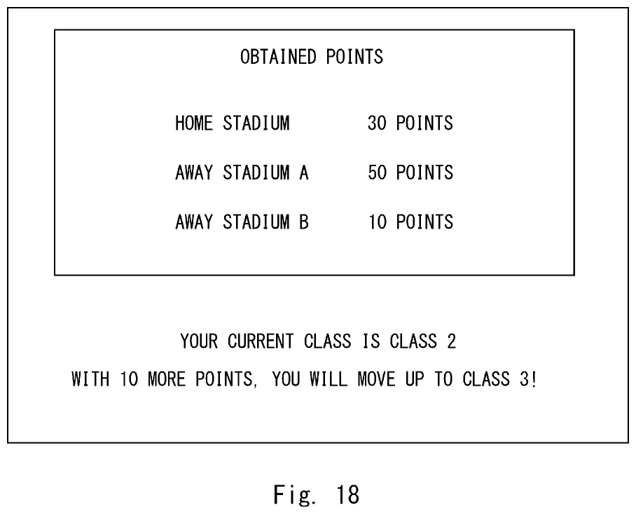

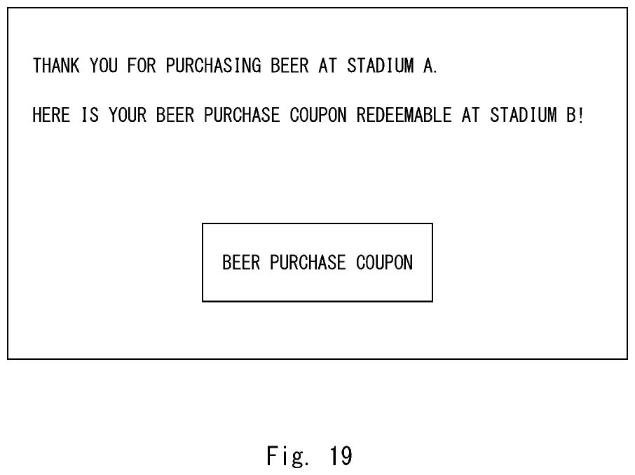

FIG. 18 shows an example of a screen displayed on the user terminal 400. For example, the screen of the user terminal 400 may display obtained points that the user has obtained or the user's current class. For example, in FIG. 18, the display screen displays that the user has accumulated, as obtained points, 30 points at the home stadium, 50 points at an away stadium A, and 10 points at an away stadium B. The obtained points are total points including, for example, visit points, purchase points, bonus points, and special points described above. In addition, the display screen displays that the user's class is Class 2. The display screen may also display how many additional points the user needs to acquire to move up to the next class. For example, in FIG. 18, “With 10 more points, you will move up to Class 3!” is displayed. The user can find out his or her currently obtained points and current class and can also find out how many points the user needs to acquire to move up to the next class. Thus, the information controlling apparatus 100a can increase a user's eagerness to visit a stadium or to make a purchase at a stadium.

An evaluation criterion for classification may include a requirement that a user needs to achieve a predetermined standard number of points at each stadium or at a target stadium to move up the class.

For example, if a predetermined standard number of points are 30 points, the display screen shown in FIG. 18 may further display that the user needs to acquire 20 additional points at the away stadium B to move up to the next class. Thus, the information controlling apparatus 100a can increase the user's eagerness to visit the away stadium B or to make a purchase at the away stadium B.

FIG. 19 shows an example of a screen displayed on the user terminal 400. For example, the screen of the user terminal 400 may display purchase information pertaining to a product or a service that the user has purchased at a stadium A as well as a service available at a stadium B determined based on the purchase information. For example, in FIG. 19, the display screen displays “Thank you for purchasing beer at Stadium A. Here is your beer purchase coupon redeemable at Stadium B!” as well as the beer purchase coupon. In other words, the information controlling apparatus 100a determines that the user likes beer based on the user's purchase information at the stadium A and provides the user with a beer purchase coupon redeemable at the stadium B. In this manner, the information controlling apparatus 100a can provide a service adapted to a user's interests and preferences and can thus increase the user's eagerness to visit a stadium or to make a purchase.

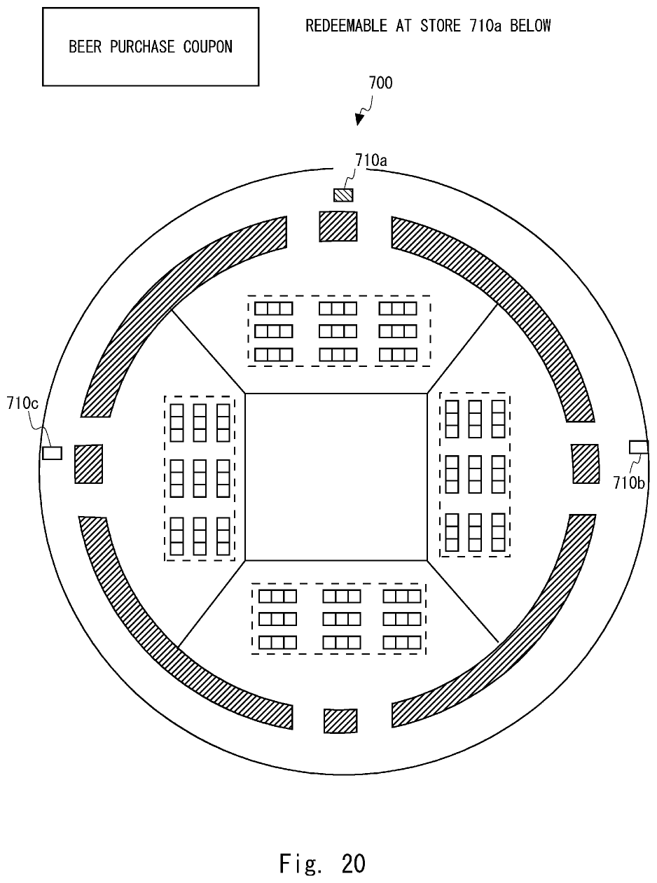

FIG. 20 shows an example of a screen displayed on the user terminal 400. For example, the screen of the user terminal 400 may display a service provided to the user and a location, on a map, where the user can use the service. In FIG. 20, a stadium 700, a store 710a, a store 710b, and a store 710c are displayed. In FIG. 20, for example, the screen displays that the beer purchase coupon provided to the user is redeemable at the store 710a in the stadium 700. This improves the user-friendliness for the user using the service.

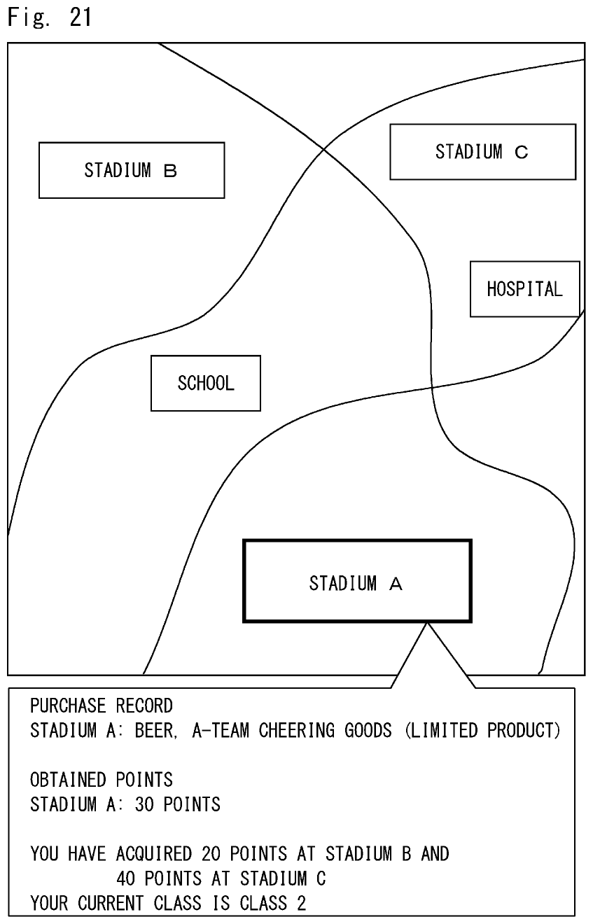

FIG. 21 shows an example of a screen displayed on the user terminal 400. For example, the screen of the user terminal 400 may display stadiums on a map and, upon an icon for a predetermined stadium having been selected, the screen may display details such as purchase records or obtained points at the selected stadium. The screen may display a stadium with a purchase record in a prominent manner. For example, the map shown in FIG. 21 displays a stadium A, a stadium B, a stadium C, a school, and a hospital. For the brevity of description, the stadium A will be described with reference to FIG. 21, but similar display may be provided for the stadium B or the stadium C as well.

For example, in FIG. 21, the stadium A is displayed in a prominent manner as the letters for the stadium A are displayed larger and enclosed by a thick-bordered frame. As shown in FIG. 21, upon the stadium B having been selected, the purchase record and the obtained points may be displayed. For example, as a purchase record at the stadium A, beer and A-team cheering goods (limited product) are displayed. Furthermore, the obtained points at the stadium A displayed indicates that the user has been given 30 points. The obtained points at other stadiums, such as the stadium B or the stadium C, may also be displayed, and the current class may also be displayed. This improves the user-friendliness.

The information controlling system 1000 shown in FIG. 10 has the components described above. The information controlling apparatus 100a acquires, via the facility terminal 500a at the first facility 610, a user's facial image captured in response to the user's entry or exit or the user's purchasing of a product or a service and causes the authentication apparatus 200 to perform biometric authentication. Thus, the information controlling apparatus 100a can register action information or purchase information of the user whose biometric authentication has succeeded with the action information or the purchase information linked to registration information and, based on the registration information, can provide a service suitable for the user U1 and available at the second facility 620.

If the user U1 has visited the second facility 620 or has purchased a product or a service at the second facility 620, the information controlling apparatus 100a acquires, via the facility terminal 500b at the second facility 620, the user's facial image captured in response to the user's entry or exit or the user's purchasing of a product or a service and causes the authentication apparatus 200 to perform biometric authentication. If the biometric authentication succeeds, the information controlling apparatus 100a registers action information or purchase information, at the second facility 620, of the user whose biometric authentication has succeeded with the action information or the purchase information linked further to the registration information. Based on the registration information, the information controlling apparatus 100a can provide a service more suitable for the user U1 and available at the second facility 620.

As described above, the information controlling apparatus 100a according to the fourth example embodiment can provide a service adapted to a user's interests and preferences and available at a different facility as well.

### OTHER EXAMPLE EMBODIMENTS

Although the information controlling apparatus 100a and the authentication apparatus 200 are different apparatuses according to the fourth example embodiment described above, the information controlling apparatus 100a and the authentication apparatus 200 may be served by the same apparatus. For example, the information controlling apparatus 100a may register the user ID 122 and the facial feature information with the facial feature information further linked to the user ID 122. In this case, the control unit 340 may include the face detecting unit 220, the feature point extracting unit 230, the registering unit 240, and the authenticating unit 250 of the authentication apparatus 200.

The information controlling apparatus 100a may perform the process described above by performing identity proving authentication, instead of biometric authentication, with use of identity proving information, instead of biometric information. For the identity proving information, for examination, a two-dimensional bar code, such as a QR code (registered trademark), that can verify the identify of an individual may be used. When a user registers registration information, a QR code may be issued as identity proving information that can uniquely identify the user and may be sent to the user terminal. In this case, the registration information may include at least the user's identity proving information for authentication and personal information. The information controlling apparatus 100a may perform the process described above through a combination of biometric authentication and identity proving authentication.

Specifically, the acquiring unit 111 may acquire a user's identity proving information in response to the user's entry into or exit from a first facility or the user's purchasing of a product or a service at a first facility. For example, a facility terminal may read a QR code the user presents, in response to the user's entry into or exit from the first facility or the user's purchasing of a product or a service at the first facility, acquire identity proving information, and transmit the acquired identity proving information to the acquiring unit 111. Thus, the acquiring unit 111 can acquire the user's identity proving information.

The biometric authentication controlling unit 112 may control, by use of the registration information, identity proving authentication of the acquired identity proving information of the user. The biometric authentication controlling unit 112 may perform identity proving authentication by comparing the acquired identity proving information against the identity proving information for authentication included in the registration information.

If the identity proving authentication succeeds, the second registering unit 113 may register action information pertaining to an entry into or exit from a first facility or purchase information pertaining to a purchased product or service linked to the user's registration information. Based on registration information, the determining unit 114 determines a service suitable for a user and available at a second facility. The processing unit 115 performs a process pertaining to providing of a service.

As described above, as a user has an issued QR code read by a facility terminal, action information pertaining to an entry or exit or purchase information pertaining to a purchased product or service may become registered linked to registration information.

The foregoing example embodiments have been described as hardware configuration, but these are not limiting examples. The present disclosure can also be implemented by causing a CPU to execute a computer program.

Although the information controlling apparatus 100a and the authentication apparatus 200 are separate apparatuses in the description according to the foregoing example embodiments, the information controlling apparatus 100a may be configured so as to include the functions of the authentication apparatus 200.

Each component according to the foregoing example embodiments may be constituted by hardware or software or both. Each component may be constituted by a single piece of hardware or software or by a plurality of pieces of hardware or software. The function (process) of each apparatus may be implemented by a computer having a central processing unit (CPU), a memory, and so on. For example, a program for performing a method according an example embodiment may be stored in a storage device, and each function may be implemented as the CPU executes the program stored in the storage device.

Various controls programs can be stored and supplied to a computer with use of various types of non-transitory computer-readable media. Non-transitory computer-readable media include various types of tangible storage media. Examples of non-transitory computer-readable media include a magnetic storage medium (e.g., flexible disk, magnetic tape, or hard disk drive), a magneto-optical storage medium (e.g., magneto-optical disk), a CD-ROM, a CD-R, a CD-R/W, and a semiconductor memory (e.g., mask ROM, programmable ROM (PROM), erasable PROM (EPROM), flash ROM, or RAM). A program may also be supplied to a computer via various types of transitory computer-readable media. Examples of such transitory computer-readable media include an electric signal, an optical signal, or an electromagnetic wave. A transitory computer-readable medium can supply a program to a computer via a wired communication line, such as an electric wire or an optical fiber, or via a wireless communication line.

The present invention is not limited by the foregoing example embodiments, and modifications can be made as appropriate within the scope that does not depart from the technical scope and spirit.

Part or the whole of the foregoing example embodiments can be expressed also as in the following supplementary notes, which are not limiting.

### (Supplementary Note 1)

An information controlling apparatus comprising:
a first registering unit configured to register registration information linking a predetermined user's biometric information and personal information;
an acquiring unit configured to acquire the biometric information of the user, in response to the user's entry into or exit from a first facility or the user's purchasing of a product or a service at the first facility;
a biometric authentication controlling unit configured to control, by use of the registration information, biometric authentication of the acquired biometric information of the user;
a second registering unit configured to, if the biometric authentication succeeds, register action information pertaining to the entry into or exit from the first facility or purchase information pertaining to the purchased product or service linked to the registration information of the user whose biometric authentication has succeeded;
a determining unit configured to determine, based on the registration information, a service suitable for the user and available at a second facility; and
a processing unit configured to perform a process pertaining to providing of the service.

### (Supplementary Note 2)

The information controlling apparatus according to Supplementary Note 1, wherein the determining unit is configured to determine, as the service, bonus information that can be used toward a payment made at the second facility.

### (Supplementary Note 3)

The information controlling apparatus according to Supplementary Note 1 or 2, wherein
the acquiring unit is configured to further acquire the biometric information of the user, in response to the user's entry into or exit from the second facility or the user's purchasing of a product or a service at the second facility,
the second registering unit is configured to, if biometric authentication at the second facility succeeds, register action information pertaining to the entry into or exit from the second facility or purchase information pertaining to the purchased product or service linked further to the registration information of the user whose biometric authentication has succeeded, and
the determining unit is configured to determine, based on the registration information, a service available at the second facility and suitable for the user whose biometric authentication at the second facility has succeeded.

### (Supplementary Note 4)

The information controlling apparatus according to Supplementary Note 3, wherein the registration information includes the action information and the purchase information at a facility other than the first and second facilities.

### (Supplementary Note 5)

The information controlling apparatus according to any one of Supplementary Notes 1 to 4, further comprising an evaluating unit configured to evaluate the user based on the action information and the purchase information, wherein
the second registering unit is configured to register evaluation information pertaining to the evaluation with the evaluation information linked to the registration information of the user whose biometric authentication has succeeded, and
the determining unit is configured to determine the service based on the evaluation information in the registration information.

### (Supplementary Note 6)

The information controlling apparatus according to Supplementary Note 5, wherein the evaluating unit is configured to evaluate the user based on the number of times the user has visited a predetermined facility within a predetermined period and a sum paid to purchase a product or a service at the predetermined facility within the predetermined period.

### (Supplementary Note 7)

The information controlling apparatus according to any one of Supplementary Notes 1 to 4, wherein the processing unit is configured to inform the user about the service at a predetermined timing.

### (Supplementary Note 8)

An information controlling method to be executed by a computer, the information controlling method comprising:
registering registration information linking a predetermined user's biometric information and personal information;
acquiring the biometric information of the user, in response to the user's entry into or exit from a first facility or the user's purchasing of a product or a service at the first facility;
controlling, by use of the registration information, biometric authentication of the acquired biometric information of the user;
if the biometric authentication succeeds, registering action information pertaining to the entry into or exit from the first facility or purchase information pertaining to the purchased product or service linked to the registration information of the user whose biometric authentication has succeeded;
determining, based on the registration information, a service suitable for the user and available at a second facility; and
performing a process pertaining to providing of the service.

### (Supplementary Note 9)

A non-transitory computer-readable medium storing a program that causes a computer to execute:
a step of registering registration information linking a predetermined user's biometric information and personal information;
a step of acquiring the biometric information of the user, in response to the user's entry into or exit from a first facility or the user's purchasing of a product or a service at the first facility;
a step of controlling, by use of the registration information, biometric authentication of the acquired biometric information of the user;
if the biometric authentication succeeds, a step of registering action information pertaining to the entry into or exit from the first facility or purchase information pertaining to the purchased product or service linked to the registration information of the user whose biometric authentication has succeeded;
a step of determining, based on the registration information, a service suitable for the user and available at a second facility; and
a step of performing a process pertaining to providing of the service.

Thus far, the invention of the present application has been described with reference to the example embodiments, but the foregoing example embodiments do not limit the invention of the present application. Various modifications that a person skilled in the art can appreciate can be made to the configurations and the details of the invention of the present application within the scope of the invention of the present application.

### REFERENCE SIGNS LIST

INFORMATION CONTROLLING APPARATUS 10, 100, 100a
FIRST REGISTERING UNIT 110
ACQUIRING UNIT 111
BIOMETRIC AUTHENTICATION CONTROLLING UNIT 112
SECOND REGISTERING UNIT 113
DETERMINING UNIT 114
PROCESSING UNIT 115
EVALUATING UNIT 116
STORAGE DEVICE 120
PERSONAL INFORMATION 121
USER ID 122
ACTION INFORMATION 123
PURCHASE INFORMATION 124
EVALUATION INFORMATION 125
AUTHENTICATION APPARATUS 200
FACIAL INFORMATION DB 210
USER ID 211
FACIAL FEATURE INFORMATION 212
FACE DETECTING UNIT 220
FEATURE POINT EXTRACTING UNIT 230
REGISTERING UNIT 240
AUTHENTICATING UNIT 250
NETWORK 300
STORAGE UNIT 310
PROGRAM 311
MEMORY 320
COMMUNICATION UNIT 330
CONTROL UNIT 340
USER TERMINAL 400
CAMERA 410
STORAGE UNIT 420
COMMUNICATION UNIT 430
DISPLAY UNIT 440
CONTROL UNIT 450
FACILITY TERMINAL 500, 500a, 500b
CAMERA 510
STORAGE UNIT 520
COMMUNICATION UNIT 530
DISPLAY UNIT 540
CONTROL UNIT 550
FIRST FACILITY 610
SECOND FACILITY 620
STADIUM 700
STORE 710a, 710b, 710c
INFORMATION CONTROLLING SYSTEM 1000

What is claimed is:

1. An information controlling apparatus comprising:
a first registering unit configured to register registration information linking a predetermined user's biometric information and personal information;
an acquiring unit configured to acquire the biometric information of the user, in response to the user's entry into or exit from a first facility or the user's purchasing of a product or a service at the first facility;
a biometric authentication controlling unit configured to control, by use of the registration information, biometric authentication of the acquired biometric information of the user,
a second registering unit configured to, if the biometric authentication succeeds, register action information pertaining to the entry into or exit from the first facility or purchase information pertaining to the purchased product or service linked to the registration information of the user whose biometric authentication has succeeded;
a determining unit configured to determine, based on the registration information, a service suitable for the user and available at a second facility; and
a processing unit configured to perform a process pertaining to providing of the service.

2. The information controlling apparatus according to claim 1, wherein the determining unit is configured to determine, as the service, bonus information that can be used toward a payment made at the second facility.

3. The information controlling apparatus according to claim 1, wherein
the acquiring unit is configured to further acquire the biometric information of the user, in response to the user's entry into or exit from the second facility or the user's purchasing of a product or a service at the second facility,
the second registering unit is configured to, if biometric authentication at the second facility succeeds, register action information pertaining to the entry into or exit from the second facility or purchase information pertaining to the purchased product or service linked to the registration information of the user whose biometric authentication has succeeded, and
the determining unit is configured to determine, based on the registration information, a service available at the second facility and suitable for the user whose biometric authentication at the second facility has succeeded.

4. The information controlling apparatus according to claim 3, wherein the registration information includes the action information and the purchase information at a facility other than the first and second facilities.

5. The information controlling apparatus according to claim 1, further comprising an evaluating unit configured to evaluate the user based on the action information and the purchase information, wherein
the second registering unit is configured to register evaluation information pertaining to the evaluation with the evaluation information linked to the registration information of the user whose biometric authentication has succeeded, and
the determining unit is configured to determine the service based on the evaluation information in the registration information.

6. The information controlling apparatus according to claim 5, wherein the evaluating unit is configured to evaluate the user based on the number of times the user has visited a predetermined facility within a predetermined period and a sum paid to purchase a product or a service at the predetermined facility within the predetermined period.

7. The information controlling apparatus according to claim 1, wherein the processing unit is configured to inform the user about the service at a predetermined timing.

8. An information controlling method to be executed by a computer, the information controlling method comprising:
registering registration information linking a predetermined user's biometric information and personal information;
acquiring the biometric information of the user, in response to the user's entry into or exit from a first facility or the user's purchasing of a product or a service at the first facility;
controlling, by use of the registration information, biometric authentication of the acquired biometric information of the user;
if the biometric authentication succeeds, registering action information pertaining to the entry into or exit from the first facility or purchase information pertaining to the purchased product or service linked to the registration information of the user whose biometric authentication has succeeded;
determining, based on the registration information, a service suitable for the user and available at a second facility; and
performing a process pertaining to providing of the service.

9. A non-transitory computer-readable medium storing a program that causes a computer to execute:
a step of registering registration information linking a predetermined user's biometric information and personal information;
a step of acquiring the biometric information of the user, in response to the user's entry into or exit from a first facility or the user's purchasing of a product or a service at the first facility;
a step of controlling, by use of the registration information, biometric authentication of the acquired biometric information of the user;
if the biometric authentication succeeds, a step of registering action information pertaining to the entry into or exit from the first facility or purchase information pertaining to the purchased product or service linked to the registration information of the user whose biometric authentication has succeeded;
a step of determining, based on the registration information, a service suitable for the user and available at a second facility; and
a step of performing a process pertaining to providing of the service.
